(19) United States
(12) Patent Application Publication
(10) Pub. No.: US 2011/0316437 A1
(43) Pub. Date: Dec. 29, 2011

(54) ELECTRONIC DEVICE FOR SWITCHING ON A FLUORESCENT LAMP AND FLUORESCENT LAMP WHICH COMPRISES SAID DEVICE

(75) Inventors: Roque Bonal Rubio, Albacete (ES); Antonio Sáez Castillo, Albacete (ES); Emilio Gómez Lázaro, Albacete (ES)

(73) Assignee: Villarrus S.L., Albacete (ES)

(21) Appl. No.: 13/141,775

(22) PCT Filed: May 7, 2009
(86) PCT No.: PCT/ES2009/070146

§ 371 Date: Sep. 7, 2011

(30) Foreign Application Priority Data
Dec. 26, 2008 (ES) P200803716

(51) Int. Cl. H05B 41/36

(52) U.S. Cl. 315/240

(57) ABSTRACT

The invention relates to an electronic device for turning on a fluorescent lamp and a fluorescent lamp comprising said device, wherein said fluorescent lamp comprises a fluorescent tube (1) having an electrical terminal (2) at each end, and wherein said fluorescent lamp is connected in parallel with an electronic module (3) and a voltage source configured to supply said fluorescent lamp, said electronic module (3) being configured to turn on a burnt-out fluorescent lamp keeping it turned on until the end of its service life as its light intensity is reduced.

### OBJECT OF THE INVENTION

The present invention relates to an electronic device for turning on a fluorescent lamp and to a fluorescent lamp comprising said device which can be used in the electrical industry, and more specifically in the area of lighting systems, which allows turning on a burnt-out fluorescent tube and regulating its light intensity.

### BACKGROUND OF THE INVENTION

The considerable electric consumption, particularly in developed countries, is known today, Within said consumption, lighting has a specific importance as fluorescent lighting is the most widespread lighting system, and is found in up to 90% of current-day facilities.

FIG. 1 depicts the circuit diagram of a lighting system with a conventional fluorescent lamp existing today, provided with an electromagnetic ballast and starter.

The operating principle of a current fluorescent lamp requires ionizing a gas inside the fluorescent tube in order to be turned on. In conventional installations today depicted in FIG. 1, the starter produces a spark through the filaments of the tube such that the gas is ionized and is kept ionized by the primary circuit through the electromagnetic ballast having the basic function of compensating for frequency interruptions.

However, European Union Directive 2000/55/CE 18/09 relating to lighting systems of this type prohibits the use of standard electromagnetic ballasts as of November 2005 and those causing the greatest losses as of May 2002.

These conventional installations have three fundamental drawbacks. The first is that that they consume 300% more than the rated consumption indicated by manufacturers for the lamp when they are turned on. The second is that during normal operation, the consumption is sometimes 100% higher than the rated consumption. The third drawback is that in these conventional systems it is not possible to regulate the brightness, i.e., the degree of light intensity.

The direct cause of the first two deficiencies is the electromagnetic ballast, and it is known by the installers, manufacturers and other agents of the sector that the real consumption values are much higher than the rated values indicated by the manufacturers of fluorescent tubes. In fact, to scale the section of the feed lines of said tubes in the calculations made in installations having fluorescent tubes, the rated power is multiplied by a factor of 1.62 for the purpose of considering the power factor in the start-up.

On the other hand, given that fluorescent tubes comprise contaminating elements that are hazardous to the health and the ecosystem, it is regulated by law that said fluorescent tubes must be handled by a specialized waste manager once the tube burns out, i.e., once it blows. The recycling cost has a direct effect on the sale of fluorescent lamps, 0.3 Euros per fluorescent tube today, which involves considerable amounts taking into account the yearly collection volume of these tubes.

FIG. 2 depicts the circuit diagram of an alternative known today to the lighting system with a conventional fluorescent lamp provided with an electromagnetic ballast and starter depicted in FIG. 1. Said alternative of FIG. 2 is known on the market as an electronic ballast and corrects the deficiencies of the conventional system described above. It is a more expensive system than the conventional system, although it is a better option because the initial price difference is made up for in a few months of operation since it has a real consumption that is very similar to the rated consumption indicated for the tube, and preventing the consumption peak when it is turned on.

In the case of installations with an electronic ballast, to ionize the gas without needing to use a starter it is necessary to have an electronic circuit increasing the voltage enough to ionize the gas, after that point having an operation that is similar to conventional systems, with the only difference being that in installations with an electronic ballast the consumption is maintained close to the rated consumption both in the start-up and during normal operation.

The regulation of the light intensity or brightness in installations with an electronic ballast is achieved through a voltage variation.

Systems with an electronic ballast allow regulating the light intensity of the installation by means of an adaptation, however the main drawback which complicates said adaptation is that it is necessary to install two additional wires or cables, as can be immediately inferred from the comparison between FIGS. 1 and 2, whereby if the labor and material costs are considered, the adaptation becomes expensive and in many cases infeasible.

In any case, no system is known today which allows turning on fluorescent tubes once they have burnt-out or blown, i.e., when one of the filaments is no longer continuous as a result of its breaking.

### DESCRIPTION OF THE INVENTION

A first aspect of the present invention relates to an electronic device for turning on a fluorescent lamp, wherein said fluorescent lamp comprises a fluorescent tube having an electrical terminal at each end such that the fluorescent lamp is connected in parallel with an electronic module and a voltage source configured to supply said fluorescent lamp. According to the invention, the electronic module is configured to turn on a blown or burnt-out fluorescent lamp, i.e., a fluorescent lamp in which at least one filament is no longer continuous as a result of its breaking, keeping it turned on until using up the gaseous material contained therein, a phenomenon that is noticeable due to the reduction of its light intensity.

The invention achieves in a single device not only the minimum elements necessary for a burnt-out fluorescent tube to be turned on, which entails economic advantages that make it an interesting device not only for the end user but also for entities, public or private companies, institutions, etc., worldwide, also being a device with a low manufacturing cost, delaying recycling and further using up the contaminating material of the fluorescent tube.

According to the invention, blown or burnt-out fluorescent tubes which can be turned on by the device are understood as those fluorescent tubes having at least one electrical terminal at each end in contact with the gas, which allows applying the invention in fluorescent tubes having both terminals, also called pins, short-circuited, or in the event that a terminal is accidentally sectioned, the other terminal allows turning on the fluorescent tube. The device of the invention can also be applied in a fluorescent tube which has instead of filaments a simple stainless steel terminal in contact with the gas, unlike terminals today which oxidize in contact with said gas.

It is contemplated that the electronic module comprises two diodes, each diode being connected in series with a capacitor, formerly referred to as a condenser, comprising a resistor connecting in parallel the series connection points between said diodes and said capacitors; also comprising a first electromagnetic ballast connected in series between a terminal of the fluorescent tube and a connection point between a diode and a capacitor, and a second electromagnetic ballast connected in series between the voltage source and the diodes.

The possibility of the electronic module being configured to regulate light intensity of the fluorescent lamp by means of electric current variation, maintaining a voltage value, which allows reducing the electric consumption to a greater extent than the light intensity reduction, is also contemplated.

In this sense, based on its technical principle the electronic module of the invention constitutes a novel system for regulating alternating current intensity, maintaining a fixed constant voltage value, with the applications it may have.

In this case, it is contemplated that the electronic module comprises two diodes, each diode being connected in series with a switch comprising a plurality of discrete positions operatively associated with a plurality of positions of a multicapacitor, said positions of said switch defining a plurality of light intensity states of the fluorescent lamp.

The electronic module also comprises a resistor connecting in parallel the series connection points between said diodes and said switches, comprising a first electromagnetic ballast connected in series between a terminal of the fluorescent tube and a connection point between a diode and a switch, and a second electromagnetic ballast connected in series between the voltage source and the diodes.

The device of the invention is configured to turn on the fluorescent lamp in the same light intensity state in which said fluorescent lamp was turned off, without needing to be turned on in the maximum power position. The device of the invention allows turning on a 30 W fluorescent tube by means of applying only 3 mA of electric current, allowing the successive turning off and turning on of the fluorescent tube at said value,

The invention contemplates several forms of regulation:
Self-controlled, i.e., the light intensity desired in a room is set upon installing the device, said light intensity being detected by means of a commercial photosensitive device configured to regulate, increasing or decreasing its intensity depending on the received signal.
Remote controlled, wherein the detection device is located in a remote control situated on a working plane where a desired lighting level is selected.
Carrier wave, where a system coupled to the supply itself of the fluorescent tube allows the simultaneous regulation of all the tubes supplied from one and the same line. The selected lighting level can be controlled manually or automatically and the signal is transferred in any case by the carrier wave.

The possibility of the electronic module being connected in parallel with a conventional fluorescent lamp comprising an electromagnetic ballast and lacking a starter is contemplated. Any lamp with a ballast that is not in accordance with legal regulations is thereby legalized by means of connecting the device of the invention, such that any high-loss electromagnetic ballast prohibited since 2002 by European Directive 2000/55 CE is within the maximum ballast-lamp circuit input power margins allowed in the aforementioned European regulation, making the assembly legal and suitable for marketing.

Maintaining an electromagnetic ballast in an existing installation and maintaining only two wires in the installation, with the device of the invention the tube is made to operate by simply removing the starter such that the electromagnetic ballast is part of the installation.

The electromagnetic ballast of the installation is thereby used for the operation of the device of the two electromagnetic ballasts required for the operation thereof, which allows reducing its cost. The device can be coupled to an existing installation by simply removing the starter and short-circuiting the terminals of each end of the fluorescent tube.

A second aspect of the invention relates to a fluorescent lamp comprising an electronic device such as the one described above.

It is contemplated that said fluorescent lamp comprises a fluorescent tube having a single terminal at each end, said terminals being in contact with the gas contained inside the fluorescent tube.

The invention efficiently solves all the problems of the state of the art. Like the electronic ballast, it complies with the rated consumption values indicated for the tubes.

Additionally, even though the tube is burnt-out, the invention turns it on and does so until the gas contained inside the tube is used up, a fact which is noticeable for the user due to the loss of brightness of the tube. The contaminating material inside the tube is thereby further used up until it is recycled, being less hazardous than when it is recycled sooner upon having burnt-out, as occurs today.

In relation to the regulation of light intensity, with respect to the electronic ballast, the invention allows decreasing the intensity but not by means of reducing the voltage. In the case of the invention the brightness is regulated by a current or intensity variation, not a voltage variation, the voltage remaining stable within the values of the system, which allows reducing consumption by up to 60% but with a feature that makes it exclusive, i.e., the brightness in that case would only drop to 50%.

Furthermore if a tube is turned off in any regulated lighting state other than the maximum state, with the invention the tube can be turned on in that same state without needing to return to the maximum initial position for turning it on, and it will gradually decrease to the desired level, all with a cost that is much lower than that of the electronic ballast and much simpler, allowing its quick installation in any existing system.

### DESCRIPTION OF THE DRAWINGS

To complement the description that is being made and for the purpose of helping to better understand the features of the invention according to a preferred practical embodiment thereof, a set of drawings is attached as an integral part of said description in which the following has been depicted with an illustrative and non-limiting character:

FIG. 1 shows a circuit diagram of a currently existing conventional installation of a fluorescent lamp comprising an electromagnetic ballast and a starter.

FIG. 2 shows a circuit diagram of a currently existing installation of a fluorescent lamp comprising an electronic ballast.

FIG. 3 shows a circuit diagram of an installation of a fluorescent lamp comprising the device of the invention.

FIG. 4 shows a schematic explanation of the circuit diagram depicted in FIG. 6.

FIG. 5 shows a circuit diagram in which an embodiment of the electronic module of the device of the invention is shown,

FIG. 6 shows a circuit diagram in which a variant of the electronic module of the device of the invention which allows regulating the light intensity of a fluorescent lamp.

FIG. 7 shows three schematic views corresponding to three possible manufacturing configurations of the multicapacitor.

FIG. 8 shows two schematic views of fluorescent lamps according to the invention having the electronic device for turning on fluorescent lamps internally built in the fluorescent tube, in view A with SMD capacitors and in View B with conventional capacitors.

FIG. 9 shows a schematic view of a fluorescent lamp according to the invention, the fluorescent tube of which comprises a single electrical terminal.

FIG. 10 shows two schematic views of a connector of fluorescent tubes with a single electrical terminal per end in installations requiring two electrical terminals, being depicted in view A in a state without being connected to the fluorescent tube and in view B in a state connected to an end of the fluorescent tube.

FIG. 11 shows two schematic views in which a conventional installation of the state of the art is depicted in view A, and an installation according to the invention is depicted in view B, the intensity and power values of the installation being depicted in both cases, the effect of the legalization of the high loss ballast being seen in the case of installation B according to the invention.

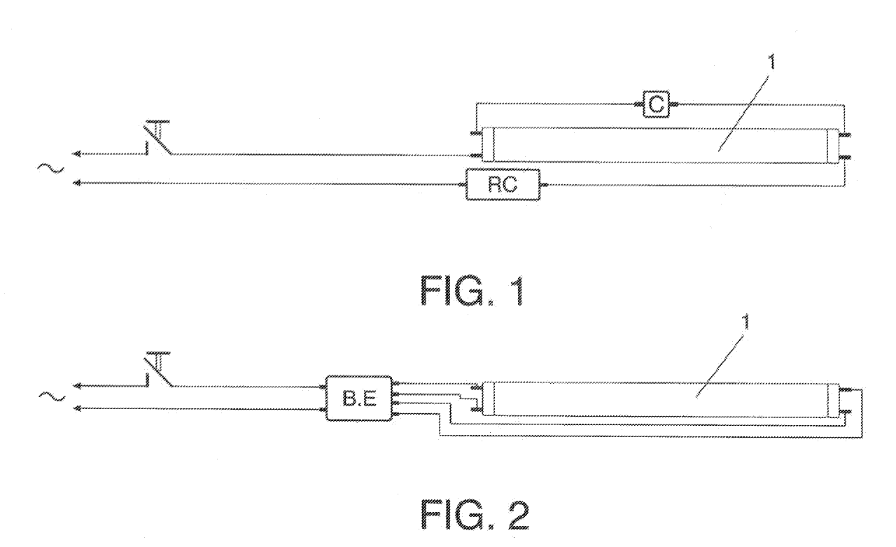

### PREFERRED EMBODIMENT INVENTION

In view of the mentioned figures, it can be observed how in one of the possible embodiments of the invention the electronic device for turning on a fluorescent lamp proposed by the invention comprises an electronic module (3) connected in parallel with a fluorescent lamp comprising a fluorescent tube (1) having an electrical terminal (2) at each end such that the fluorescent lamp is connected in parallel with the electronic module (3) and a voltage source configured to supply said fluorescent lamp,

The electronic module (3) is configured to turn on a burnt-out, i.e. blown, fluorescent lamp, keeping it turned on until the end of the duration of the gas therein, the using up of this gas being noticeable due to the reduction of its light intensity.

Blown or burnt-out fluorescent tubes (1) are understood as those having at least one electrical terminal (2) at each end in contact with the gas which allows applying the invention in fluorescent tubes (1) having both terminals short-circuited. The device of the invention can also be applied in a fluorescent tube (1) which has, instead of filaments, a simple stainless steel terminal in contact with the gas.

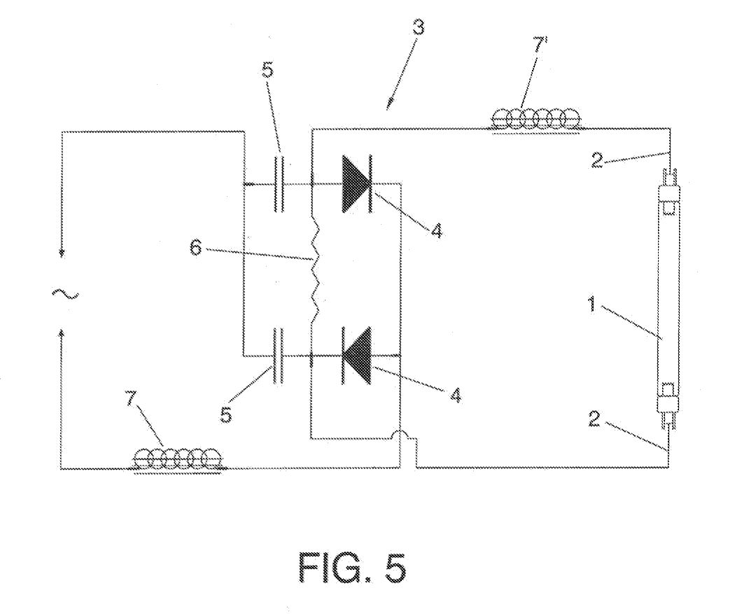

As can be seen in FIG. 5, the electronic module (3) comprises two diodes (4), each diode (4) being connected in series with a capacitor (5), comprising a resistor (6) connecting in parallel the series connection points between said diodes (4) and said capacitors (5); also comprising a first electromagnetic ballast (7) connected in series between a terminal (2) of the fluorescent tube (1) and a connection point between a diode (4) and a capacitor (5), and a second electromagnetic ballast (7′) connected in series between the voltage source and the diodes (4).

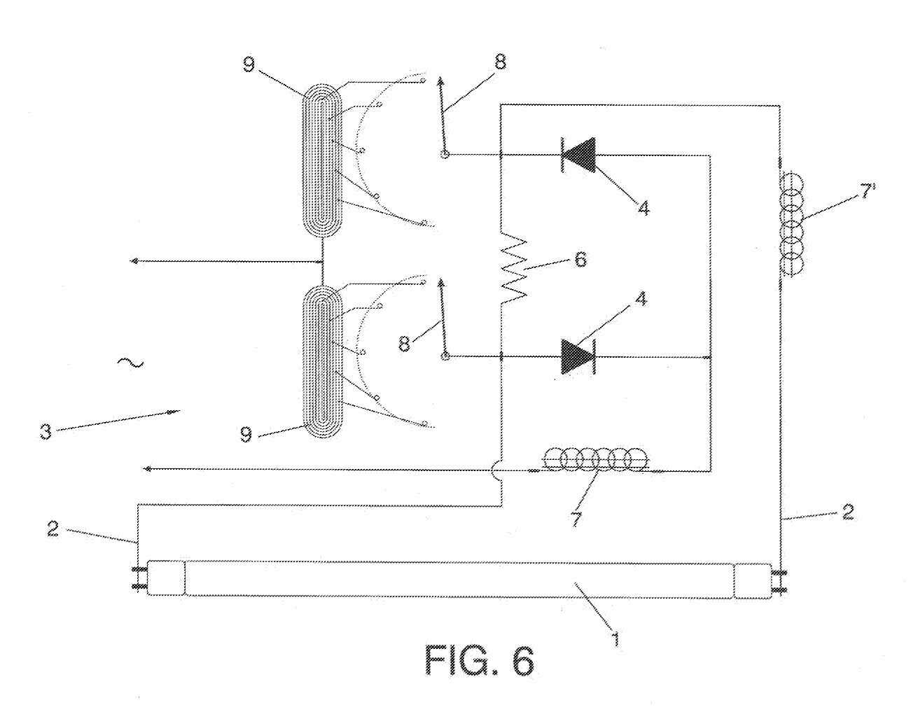

The electronic module (3) is also configured to regulate light intensity of the fluorescent lamp by means of electric current variation, maintaining a voltage value, which allows reducing the electric consumption to a greater extent than the light intensity reduction. In this case, as depicted in the embodiment of FIG. 6, the electronic module (3) comprises two diodes (4), each diode (4) being connected in series with a switch (8) comprising a plurality of discrete positions operatively associated with a plurality of positions of a multicapacitor (9), said positions of said switch (8) defining a plurality of light intensity states of the fluorescent lamp.

The electronic module (3) also comprises a resistor (6) connecting in parallel the series connection points between said diodes (4) and said switches (8), comprising a first electromagnetic ballast (7) connected in series between a terminal (2) of the fluorescent tube (1) and a connection point between a diode (4) and a switch (8), and a second electromagnetic ballast (7′) connected in series between the voltage source and the diodes (4).

The device of the invention is configured to turn on the fluorescent lamp in the same light intensity state in which said fluorescent lamp was turned off, without needing to be turned on in the maximum power position.

The invention allows the electronic module (3) to be connected in parallel with a conventional fluorescent lamp comprising a second electromagnetic ballast (7′) and lacking a starter, Maintaining an electromagnetic ballast (7) in an existing installation and maintaining only two wires in the installation, with the device of the invention the fluorescent tube (1) is able to operate by simply removing the starter such that the second electromagnetic ballast (7′) is part of the installation.

As schematically depicted in FIG. 4, the invention triples the input voltage in a much more economical manner than the devices of the state of the art due to the few necessary components and the reduced cost thereof by means of the effect of a voltage tripler (10), at a value capable of ionizing the gas, this vacuum voltage increase being momentary until being turned on and then dropping to half the rated input voltage, doubling the frequency by means of the effect of a frequency doubler (11), and getting the variation of the capacity of the multicapacitor (9) to vary only the current by means of the effect of a current regulator (12), which determines the value of the selected brightness.

The simple fact of doubling the frequency and tripling the voltage simultaneously allows the gas to be ionized by turning on the tube, the voltage then dropping to half the rated value and the brightness remaining stable provided that the two electromagnetic ballasts (7, 7′) are arranged according to the diagram of FIG. 5. These results obtained at the output enable not having to close circuits through filaments, because the simple fact of there being direct physical contact of the terminals of the circuit with the gas allows turning the tube on and the operation thereof until the existing gas is used up.

The resistor (6) of the circuit is arranged so that when the circuit is deactivated, the capacitors (5, 9) discharge through it for the safety of the system and the resetting thereof. The values of the capacitors (5, 9) must necessarily be in accordance with the consumption of the circuit to which it is applied, as well as the electromagnetic ballasts (7, 7′).

The voltage is thereby kept at a constant value such that the brightness variation is achieved through the current variation, and this is achieved by varying the value of the multicapacitors (9) of the circuit diagram, either by the use of a combination of several capacitors (5) with equal or different values, or by the use of two multicapacitors (9), which scheme allows reducing the brightness and the consumption to a value of less than 10% of its rated value and turning it off at any brightness value and turning it on at that same value, all this by regulating very low values maintaining a noticeable brightness, reducing the power consumption much more than the brightness level and all at a very low cost which, due to the few elements used, the low cost thereof and their proven reliability, allows, recommends and justifies the implementation thereof.

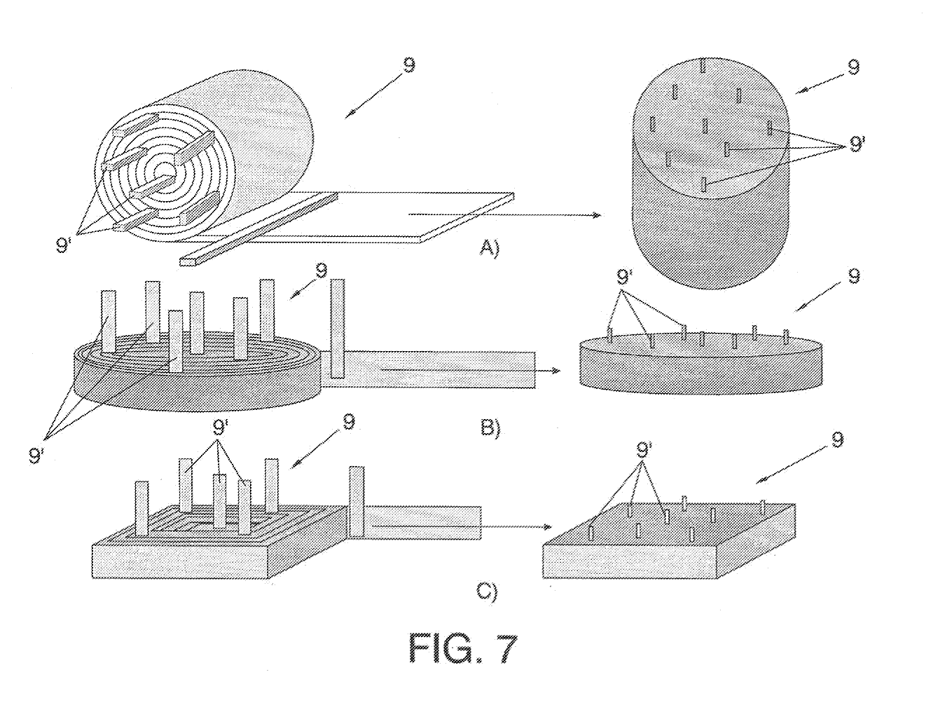

FIG. 7 depicts three possible manufacturing configurations of the multicapacitor (9) consisting of a non-electrolytic multicapacitor (9) comprising at least three outputs (9′) or pins which are distributed along a winding length, said outputs (9′) being configured to allow achieving the different regulation states required; i.e., if a multicapacitor (9) with 10 outputs (9′) and with proportional jumps (10%, 20%, 30%, and successively up to 100%) is desired, 11 outputs (9′) are arranged separated from one another by the same distance upon winding the material. If only three states are desired, for example 10%, 40% and 100%, four outputs (9′) are arranged, the common state and three states, situated at 0, 10, 40 and 100 units of length of the material, assuming a total measurement of 100 units, In other words, there is a proportionality between the desired regulation state and the arrangement of the output (9′) corresponding to that state on the length of the material.

The external format of the multicapacitor (9) can vary as needed, always with multiple outputs (9′) and round shapes, square shapes, etc, The multicapacitor (9) is the ideal component in circuits where there is a need to vary the capacity values, increasing or decreasing them. The multicapacitor (9) is the ideal component preventing the problems of induction in electronics caused by the proximity of circuits using capacitors, in addition to the comfort of using a single element. The main use of the multicapacitor (9) is the integration thereof in the circuit of the device of the invention with regulation, this part allowing the brightness variation by varying the consumption, intensity, and all this while maintaining the voltage and the frequency at a constant level, being exclusively novel as no transformer is needed for such event to occur.

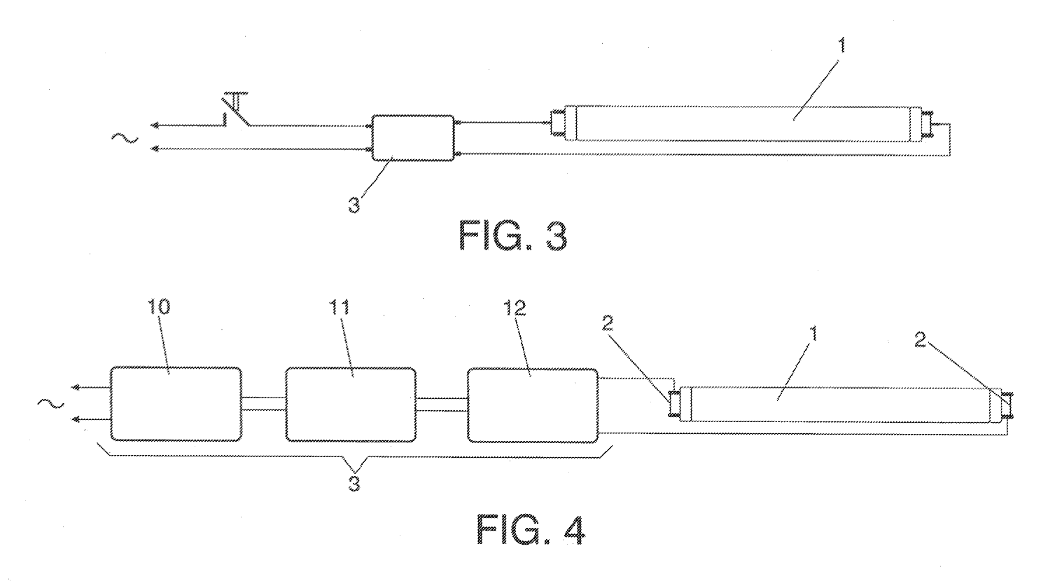

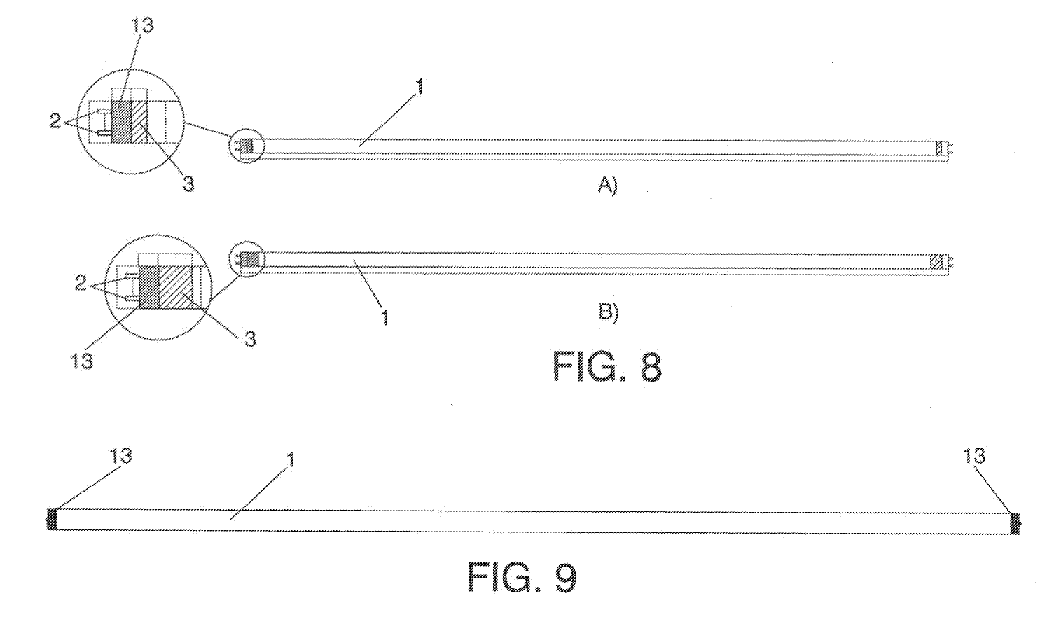

FIG. 8 depicts two fluorescent lamps according to the invention in which the fluorescent tube (1) has the electronic module (3) built in internally at its ends which is allowed because of its reduced size by means of reducing only the length of the lighting surface between 9-19 mm, depending on whether SMD capacitors depicted in view A, or conventional capacitors depicted in view B are used. Therefore by simply installing this new tube in a starter and ballast system, replacing the starter with an inductor according to the tube, the conventional system can be converted into a new electronic system, maintaining the diagram depicted in FIG. 3.

FIG. 9 depicts a fluorescent lamp according to the invention, the fluorescent tube (1) of which comprises a single electrical terminal (2).

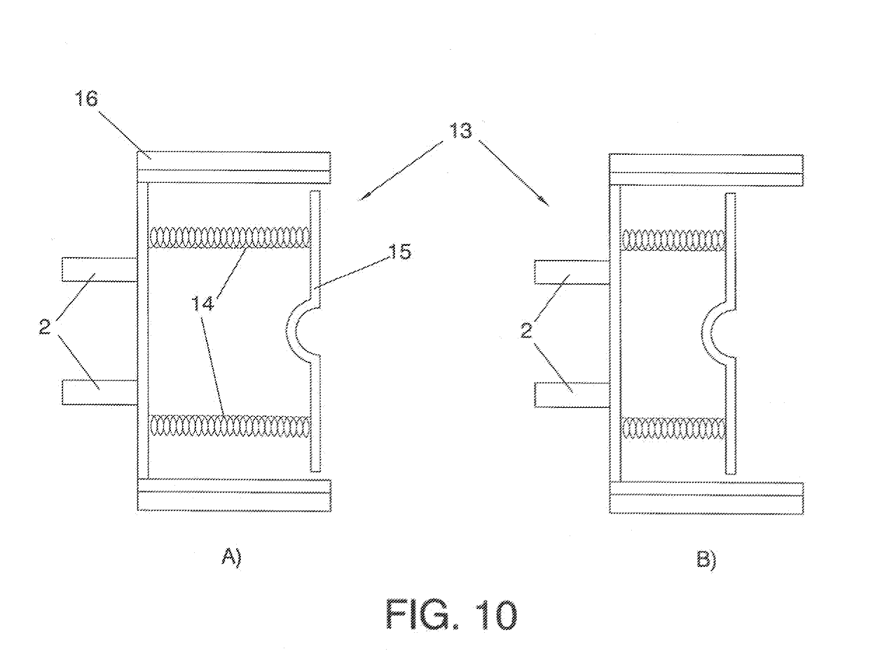

FIG. 10 shows two schematic views of a connector (13) of fluorescent tubes (1) with a single electrical terminal (2) per end in installations requiring two electrical terminals (2), depicting in view A a state that is not connected to the fluorescent tube (1) and in view B a state that is connected to an and of the fluorescent tube (1). The connector-adaptor (13) transforms the current two connection pins (2) into just one for the placement of the fluorescent tube (1) with a single pin (2), comprising for that purpose elastic means (14), such as springs, acting on a plate (15) configured to be in contact with the single terminal (2) of the tube (1), all being arranged in a casing (16) externally incorporating two electrical terminals (2).

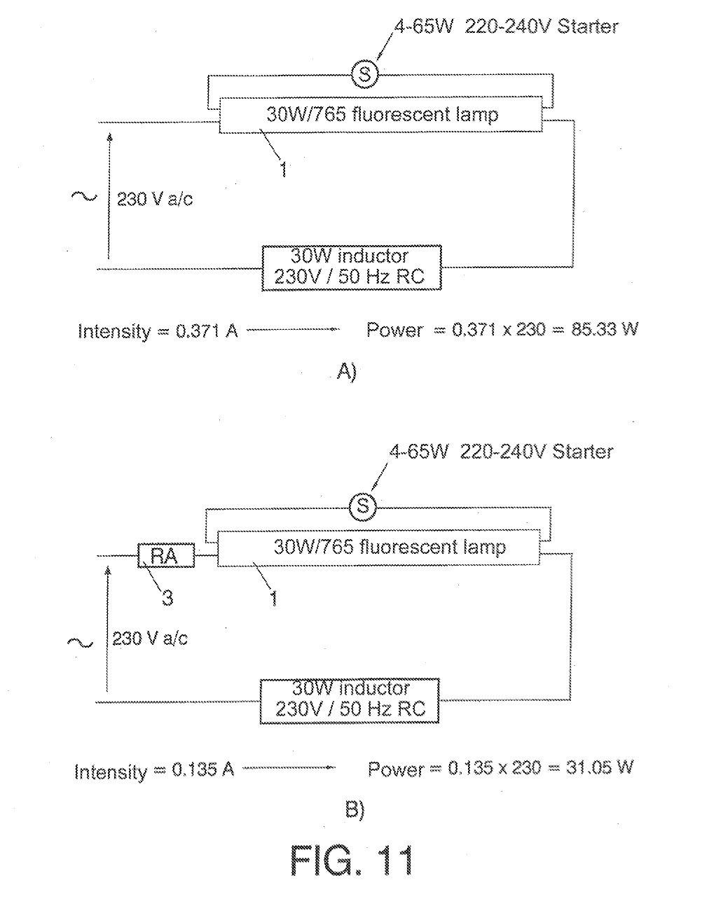

FIG. 11 shows two schematic views in which a conventional installation of the state of the art is depicted in view A, and an installation according to the invention is depicted in view B, the intensity and power values of the installation being depicted in both cases, showing the effect of legalizing a high loss ballast in the case of installation B according to the invention, as well as the proportionality existing between the brightness and the consumption.

Any lamp with a ballast that is outside regulations can thereby be legalized by means of connecting the device of the invention, such that any high loss electromagnetic ballast prohibited since 2002 by European Directive 2000/55 CE is within the maximum ballast-lamp circuit input margins allowed in the aforementioned European regulation, making the assembly legal and suitable for marketing.

In view of this description and set of drawings, the person skilled in the art will be able to understand that the embodiments of the described invention can be combined in many ways within the object of the invention. The invention has been described according to several preferred embodiments thereof, but for the person skilled in the art it will be evident that multiple variations can be introduced in said preferred embodiments without exceeding the object of the claimed invention.

1. Electronic device for turning on a fluorescent lamp, characterized in that said fluorescent lamp comprises a fluorescent tube (1) having an electrical terminal (2) at each end, wherein said fluorescent lamp is connected in parallel with an electronic module (3) and a voltage source configured to supply said fluorescent lamp, said electronic module (3) being configured to turn on a burnt-out fluorescent lamp keeping it turned on until using up the gas contained therein.

2. Electronic device for turning on a fluorescent lamp according to claim 1, characterized in that the electronic module (3) comprises two diodes (4), each diode (4) being connected in series with a capacitor (5), comprising a resistor (6) connecting in parallel the series connection points between said diodes (4) and said capacitors (5); also comprising a first electromagnetic ballast (7) connected in series between a terminal (2) of the fluorescent tube (1) and a connection point between a diode (4) and a capacitor (5), and a second electromagnetic ballast (7′) connected in series between the voltage source and the diodes (4).

3. Electronic device for turning on a fluorescent lamp according to claim 1, characterized in that the electronic module (3) is configured to regulate light intensity of the fluorescent lamp by means of electric current variation, maintaining a voltage value, which allows reducing the electric consumption to a greater extent than the light intensity reduction.

4. Electronic device for turning on a fluorescent lamp according to claim 3, characterized in that the electronic module (3) comprises two diodes (4), each diode (4) being connected in series with a switch (8) comprising a plurality of discrete positions operatively associated with a plurality of positions of a multicapacitor (9), said positions of said switch (8) defining a plurality of light intensity states of the fluorescent lamp; the electronic module (3) also comprises a resistor (6) connecting in parallel the series connection points between said diodes (4) and said switches (8); also comprising a first electromagnetic ballast (7) connected in series between a terminal (2) of the fluorescent tube (1) and a connection point between a diode (4) and a switch (8), and a second electromagnetic ballast (7′) connected in series between the voltage source and the diodes (4).

5. Electronic device for turning on a fluorescent lamp according to claim 4, characterized in that the multicapacitor (9) is not electrolytic and comprises at least three outputs (9′) which are distributed along a winding length, said outputs (9′) being configured to allow achieving the different regulation states required.

6. Electronic device for turning on a fluorescent lamp according to claim 3, characterized in that it is configured to turn on the fluorescent lamp in the same light intensity state in which said fluorescent lamp was turned off, without needing to be turned on in the maximum power position.

7. Electronic device for turning on a fluorescent lamp according to claim 1, characterized in that the electronic module (3) is connected in parallel with a conventional fluorescent lamp comprising an electromagnetic ballast (7) and lacking a starter.

8. Fluorescent lamp, characterized in that it comprises an electronic device according to claim 1.

9. Fluorescent lamp according to claim 8, characterized in that it comprises a fluorescent tube (1) having a single terminal (2) at each end, said terminals (2) being in contact with the gas contained inside the fluorescent tube (1).

10. Fluorescent lamp according to claim 9, characterized in that a fluorescent tube (1) has the electronic module (3) internally built in at its ends.

11. Fluorescent lamp according to claim 9, characterized in that it comprises connectors (13) configured to adapt a fluorescent tube (1) having a single electrical terminal (2) at each end in installations requiring two electrical terminals (2) per end.
